(19) United States
(12) Patent Application Publication
(10) Pub. No.: US 2024/0331063 A1
(43) Pub. Date: Oct. 3, 2024

(54) Method and Apparatus for Optimizing Operation of Transformer Substation

(71) Applicant: Siemens Aktiengesellschaft, München (DE)

(72) Inventors: Yu Xia, Beijing (CN); De Hui Wang, Beijing (CN)

(73) Assignee: Siemens Aktiengesellschaft, München (DE)

(21) Appl. No.: 18/293,121

(22) PCT Filed: Jul. 30, 2021
(86) PCT No.: PCT/CN2021/109874

§ 371 Date: Jan. 29, 2024

(51) Int. Cl. G06Q 50/06; G06Q 10/04

(52) U.S. Cl. CPC G06Q 50/06; G06Q 10/04

(57) ABSTRACT

Various embodiments of the teachings herein include a method for optimizing operation of a transformer substation with transformers connected or disconnected by switches. The method may include: acquiring a current load of each transformer, and predicting loads for each in various operating modes in some time periods based on current loads; calculating transformer costs for each time period based on predicted loads including transformer losses and operation costs; calculating switch costs based on purchase cost and service life for a switch corresponding to each transformer; and calculating a total cost in a total time period using the transformer costs and the switch costs, optimizing the total cost to obtain optimization parameters, and operating the transformer substation according to the optimization parameters, the total time period consisting of the plurality of time periods.

### CROSS-REFERENCE TO RELATED APPLICATIONS

This application is a U.S. National Stage Application of International Application No. PCT/CN2021/109874 filed Jul. 30, 2021, which designates the United States of America, the contents of which are hereby incorporated by reference in their entirety.

### TECHNICAL FIELD

The present disclosure relates to the technical field of energy. Various embodiments of the teachings herein include methods and/or apparatus for optimizing the operation of a transformer substation.

### BACKGROUND

Transformers are one of the most important and common devices in energy systems. The energy consumption of transformers accounts for a large proportion of the overall energy loss. Therefore, optimizing the operation of transformers is an important topic for energy conservation and emission reduction.

In a substation, transformers may operate in different modes. For example, a transformer may run alone or simultaneously with other transformers. Different modes will result in different amounts of energy consumption. In the prior art, one method for optimizing transformer operations is to firstly plot the curves of all possible operating models and determine the operating models for individual time periods based on the intersection points of the curves. However, this method requires plotting the curves of all possible operating models in advance. In consideration of the cost factors and the limited optimization time domain, repeated switching may occur near an intersection, which will reduce the service life of the transformer and at the same time increase power consumption.

### SUMMARY

To solve the technical problems stated above, the present disclosure describes methods and apparatus for optimizing the operation of a transformer substation to reduce the energy consumption during the operation of the substation and improve the intelligence and flexibility of the operation of the substation. For example, some embodiments include a method (200) for optimizing operation of a transformer substation, the transformer substation comprising a plurality of transformers, the transformers being connected or disconnected by means of switches, characterized in that the optimization method (200) comprises: acquiring a current load of each of the plurality of transformers, and predicting predicted loads of each of the transformers in various possible operating modes in a plurality of time periods based on the current load (210); calculating transformer costs of each of the transformers in the plurality of time periods based on the predicted loads of each of the transformers, the transformer costs comprising transformer losses and transformer operation costs (220); calculating switch costs in the plurality of time periods based on a purchase cost and a service life of a switch corresponding to each of the transformers (230); and calculating a total cost in a total time period based on the transformer costs and the switch costs, optimizing the total cost to obtain optimization parameters, and operating the transformer substation according to the optimization parameters, the total time period consisting of the plurality of time periods (240).

In some embodiments, the following formulas are used to calculate transformer costs of each of the transformers in the plurality of time periods based on the predicted loads of each of the transformers:

$${Cost\_trans}_{i} = {\sum }_{t = 1}^{T} {Co\_trans}_{i , t} \qquad \# ( 1 )$$

$${Co\_trans}_{i , t} = {Loss\_trans}_{i , t} + {Op\_trans}_{i , t} \qquad \# ( 2 )$$

$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$

$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$

$${Op\_trans}_{i , t} = {Trans}_{i , t} * ( {Pf}_{t} + {Pu}_{t} ) \qquad \# ( 5 )$$

wherein Cost_transᵢ represents the transformer costs in the ith time period, Co_trans_{i,t} represents the transformer costs of the tth transformer in the ith time period, Loss transit represents the loss of the tth transformer in the ith time period, Op_trans_{i,t} represents the operation costs of the tth transformer in the ith time period, P0ₜ represents the active power of the tth transformer without load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer.

In some embodiments, the following formulas are used to calculate switch costs in the plurality of time periods based on a purchase cost and a service life of a switch corresponding to each of the transformers:

$${Cost\_breaker}_{i} = {\sum }_{n = 1}^{N} {Co\_breaker}_{i , n} \qquad \# ( 6 )$$

$${Co\_breaker}_{i , n} = {Br}_{i , n} * \frac{1}{{L}_{n}} * {C\_breaker}_{n} \qquad \# ( 7 )$$

wherein Cost_breakerᵢ represents the switch costs in the ith time period, Co_breaker_{i,n} represents the switch costs of the nth switch in the ith time period, Br_{i,n} represents whether the nth switch is ON in the ith time period, Lₙ represents the service life of the nth switch, and C_breakerₙ represents the purchase cost of the nth switch.

In some embodiments, the following formulas are used to calculate a total cost in a total time period based on the transformer costs and the switch costs and optimize the total cost to obtain optimization parameters:

$${Cost}_{i} = {Cost\_breaker}_{i} + {Cost\_trans}_{i} \qquad \# ( 8 )$$

$$Min ( {\int }_{i = 1}^{F} dt * {Cost}_{i} ) \qquad \# ( 9 )$$

$${Pl}_{i , t} \leq {Ps}_{t} \qquad \# ( 10 )$$

$${Pl}_{i , 1} + {Pl}_{i , 2} + … + {Pl}_{i , t} = {Load}_{i} \qquad \# ( 11 )$$

$${\sum }_{t = 1}^{T} ( {Trans}_{i , t} - {Trans}_{i - 1 , t} ) \leq 1 \qquad \# ( 12 )$$

wherein formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period.

In some embodiments, the method (200) further comprises: calculating power reliability costs based on the predicted loads of each of the transformers, and calculating the total cost based on the transformer costs, the switch costs, and the power reliability costs.

In some embodiments, the following formula is used to calculate power reliability costs based on the predicted loads of each of the transformers:

$${Cost\_other}_{i} = \frac{1}{10 {\sum }_{t = 1}^{T} {Trans}_{i , t}} * {Load}_{i} \qquad ( 13 )$$

wherein Cost_otherᵢ represents the power reliability cost, Trans_{i,t} represents whether the tth transformer is online in the ith time period, and Loadᵢ represents the predicted load in the ith time period.

As another example, some embodiments include an apparatus (300) for optimizing operation of a transformer substation, the transformer substation comprising a plurality of transformers, the transformers being connected or disconnected by means of switches, characterized in that the optimization apparatus (300) comprises: a predicting module (310) that acquires a current load of each of the plurality of transformers and predicts predicted loads of each of the transformers in various possible operating modes in a plurality of time periods based on the current load; a first calculating module (320) that calculates transformer costs of each of the transformers in the plurality of time periods based on the predicted loads of each of the transformers, the transformer costs comprising transformer losses and transformer operation costs; a second calculating module (330) that calculates switch costs in the plurality of time periods based on a purchase cost and a service life of a switch corresponding to each of the transformers; and an optimizing module (340) that calculates a total cost in a total time period based on the transformer costs and the switch costs, optimizes the total cost to obtain optimization parameters, and operates a transformer substation according to the optimization parameters, the total time period consisting of the plurality of time periods.

In some embodiments, the following formulas are used to calculate transformer costs of each of the transformers in the plurality of time periods based on the predicted loads of each of the transformers:

$${Cost\_trans}_{i} = {\sum }_{t = 1}^{T} {Co\_trans}_{i , t} \qquad \# ( 1 )$$

$${Co\_trans}_{i , t} = {Loss\_trans}_{i , t} + {Op\_trans}_{i , t} \qquad \# ( 2 )$$

$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$

$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$

$${Op\_trans}_{i , t} = {Trans}_{i , t} * ( {Pf}_{t} + {Pu}_{t} ) \qquad \# ( 5 )$$

wherein Cost_transᵢ represents the transformer costs in the ith time period, Co_trans_{i,t} represents the transformer costs of the tth transformer in the ith time period, Loss_trans_{i,t} represents the loss of the tth transformer in the ith time period, Op_trans_{i,t} represents the operation costs of the tth transformer in the ith time period, P0ₜ represents the active power of the tth transformer without: load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer.

In some embodiments, the following formulas are used to calculate switch costs in the plurality of time periods based on a purchase cost and a service life of a switch corresponding to each of the transformers:

$${Cost\_breaker}_{i} = {\sum }_{n = 1}^{N} {Co\_breaker}_{i , n} \qquad \# ( 6 )$$

$${Co\_breaker}_{i , n} = {Br}_{i , n} * \frac{1}{{L}_{n}} * {C\_breaker}_{n} \qquad \# ( 7 )$$

wherein Cost_breakerᵢ represents the switch costs in the ith time period, Co_breaker_{i,n} represents the switch costs of the nth switch in the ith time period, Br_{i,n} represents whether the nth switch is ON in the ith time period, Lₙ represents the service life of the nth switch, and C_breakerₙ represents the purchase cost of the nth switch.

In some embodiments, the following formulas are used to calculate a total cost in a total time period based on the transformer costs and the switch costs and optimize the total cost to obtain optimization parameters:

$${Cost}_{i} = {Cost\_breaker}_{i} + {Cost\_trans}_{i} \qquad \# ( 8 )$$

$$Min ( {\int }_{i = 1}^{F} dt * {Cost}_{i} ) \qquad \# ( 9 )$$

$${Pl}_{i , t} \leq {Ps}_{t} \qquad \# ( 10 )$$

$${Pl}_{i , 1} + {Pl}_{i , 2} + … + {Pl}_{i , t} = {Load}_{i} \qquad \# ( 11 )$$

$${\sum }_{t = 1}^{T} ( {Trans}_{i , t} - {Trans}_{i - 1 , t} ) \leq 1 \qquad \# ( 12 )$$

wherein formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period.

In some embodiments, the apparatus (300) further comprises: calculating power reliability costs based on the predicted loads of each of the transformers, and calculating the total cost based on the transformer costs, the switch costs and the power reliability costs.

In some embodiments, the following formula is used to calculate power reliability costs based on the predicted loads of each of the transformers:

$${Cost\_other}_{i} = \frac{1}{10 {\sum }_{t = 1}^{T} {Trans}_{i , t}} * {Load}_{i} \qquad ( 13 )$$

wherein Cost_otherᵢ represents the power reliability cost, Trans_{i,t} represents whether the tth transformer is online in the ith time period, and Load represents the predicted load in the ith time period.

As another example, some embodiments include an electronic device (400), comprising a processor (410), a memory (420) and an instruction stored in the memory (420), wherein the instruction, when executed by the processor (410), implements one or more of the methods described herein.

As another example, some embodiments include a computer-readable storage medium, with a computer instruction stored thereon, which, when run, executes one or more of the methods described herein.

### BRIEF DESCRIPTION OF THE DRAWINGS

The following drawings are only intended to illustrate and explain teachings of the present disclosure schematically, and do not limit the scope of the present disclosure. In the drawings:

FIG. 1 is a schematic diagram of the transformer operation modes in the prior art;

FIG. 2 is a flowchart of an example method for optimizing the operation of a transformer substation incorporating teachings of the present disclosure;

FIG. 3 is a schematic diagram of an example apparatus for optimizing the operation of a transformer substation incorporating teachings of the present disclosure; and

FIG. 4 is a schematic diagram of an example electronic device incorporating teachings of the present disclosure.

### REFERENCE NUMERALS IN THE DRAWINGS

200 Method for optimizing the operation of a transformer substation
210-240 method elements
300 apparatus for optimizing the operation of a transformer substation
310 predicting module
320 first calculating module
330 second calculating module
340 optimizing module
400 electronic device
410 processor
420 memory

### DETAILED DESCRIPTION

To achieve the above purposes, the present disclosure describes a method for optimizing the operation of a transformer substation, the transformer substation comprising a plurality of transformers, the transformers being connected or disconnected by means of switches, the optimization method comprising: acquiring a current load of each of the plurality of transformers, and predicting predicted loads of each of the transformers in various possible operating modes in a plurality of time periods based on the current load; calculating transformer costs of each of the transformers in the plurality of time periods based on the predicted loads of each of the transformers, the transformer costs comprising transformer losses and transformer operation costs; calculating switch costs in the plurality of time periods based on a purchase cost and a service life of a switch corresponding to each of the transformers; calculating a total cost in a total time period based on the transformer costs and the switch costs, optimizing the total cost to obtain optimization parameters, and operating the transformer substation according to the optimization parameters, the total time period consisting of the plurality of time periods. To this end, predicted loads of the transformers are predicted based on the current loads, the total cost in the total time period is calculated based on the transformer costs and the switch costs, and the total cost is optimized to obtain optimization parameters, which can be applied to the global time dimension without calculating the threshold in advance, thus preventing repeated switching of the operating modes near the threshold, eliminating the increase in losses and energy consumption due to unnecessary operations, reducing the operation loss and the energy usage costs, and improving the operation accuracy.

In some embodiments, the following formulas are used to calculate the transformer costs of the transformers in the plurality of time periods based on the predicted loads of each of the transformers:

$${Cost\_trans}_{i} = {\sum }_{t = 1}^{T} {Co\_trans}_{i , t} \qquad \# ( 1 )$$

$${Co\_trans}_{i , t} = {Loss\_trans}_{i , t} + {Op\_trans}_{i , t} \qquad \# ( 2 )$$

$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$

$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$

$${Op\_trans}_{i , t} = {Trans}_{i , t} * ( {Pf}_{t} + {Pu}_{t} ) \qquad \# ( 5 )$$

In the formulas, Cost_transᵢ represents the transformer costs in the ith time period, Co_trans_{i,t} represents the transformer costs of the tth transformer in the ith time period, Loss_trans_{i,t} represents the loss of the tth transformer in the ith time period, Op_trans_{i,t} represents the operation costs of the tth transformer in the ith time period, P0ₜ represents the active power of the tth transformer without load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer. Therefore, a method for calculating transformer costs is provided.

In some embodiments, the following formulas are used to calculate the switch costs in the plurality of time periods based on the purchase cost and service life of the switch corresponding to each of the transformers:

$${Cost\_breaker}_{i} = {\sum }_{i = 1}^{N} {Co\_breaker}_{i , n} \qquad \# ( 6 )$$

$${Co\_breaker}_{i , n} = {Br}_{i , n} * \frac{1}{{L}_{n}} * {C\_breaker}_{n} \qquad \# ( 7 )$$

In the formulas, Cost_breakerᵢ represents the switch costs in the ith time period, Co_breaker_{i,n} represents the switch costs of the nth switch in the ith time period, Br_{i,n} represents whether the nth switch is on in the ith time period, Lₙ represents the service life of the nth switch, and C_breakerₙ represents the purchase cost of the nth switch. Therefore, a method for calculating switch costs is provided.

In some embodiments, the following formulas are used to calculate the total cost in the total time period based on the transformer costs and the switch costs and optimize the total cost to obtain optimization parameters:

$${Cost}_{i} = {Cost\_breaker}_{i} + {Cost\_trans}_{i} \qquad \# ( 8 )$$

$$Min ( {\int }_{i = 1}^{F} dt * {Cost}_{i} ) \qquad \# ( 9 )$$

$${Pl}_{i , t} \leq {Ps}_{t} \qquad \# ( 10 )$$

$${Pl}_{i , 1} + {Pl}_{i , 2} + … + {Pl}_{i , t} = {Load}_{i} \qquad \# ( 11 )$$

$${\sum }_{t = 1}^{T} ( {Trans}_{i , t} - {Trans}_{i - 1 , t} ) \leq 1 \qquad \# ( 12 )$$

In the formulas, formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period. Therefore, an algorithm for optimizing transformer operation is provided.

In some embodiments, the method further comprises: calculating power reliability costs based on the predicted loads of each of the transformers, and calculating the total cost based on the transformer costs, the switch costs and the power reliability costs. Therefore, the reliability cost is considered and added as a factor to improve the accuracy of transformer operation.

In some embodiments, the following formula is used to calculate the power reliability cost based on the predicted loads of each of the transformers:

$${Cost\_other}_{i} = \frac{1}{10 {\sum }_{t = 1}^{T} {Trans}_{i , t}} * {Load}_{i} \qquad ( 13 )$$

In the formula, Cost_otherᵢ represents the power reliability cost, Trans_{i,t} represents whether the tth transformer is online in the ith time period, and Loadᵢ represents the predicted load in the ith time period. Therefore, a method for calculating power reliability costs is provided.

Some embodiments of the teachings herein include an apparatus for optimizing the operation of a transformer substation, the transformer substation comprising a plurality of transformers, the transformers being connected or disconnected by means of switches, characterized in that the optimization apparatus comprises: a predicting module that acquires a current load of each of the plurality of transformers and predicts predicted loads of each of the transformers in various possible operating modes in a plurality of time periods based on the current load; a first calculating module that calculates transformer s of each of the transformers in the plurality of time periods based on the predicted loads of each of the transformers, the transformer costs comprising transformer losses and transformer operation costs; a second calculating module that calculates switch costs in the plurality of time periods based on a purchase cost and a service life of a switch corresponding to each of the transformers; and an optimizing module that calculates a total cost in a total time period based on the transformer costs and the switch costs, optimizes the total cost to obtain optimization parameters, and operates a transformer substation according to the optimization parameters, the total time period consisting of the plurality of time periods.

In some embodiments, the following formulas are used to calculate the transformer costs of each of the transformers in the plurality of time periods based on the predicted loads of each of the transformers:

$${Cost\_trans}_{i} = {\sum }_{t = 1}^{T} {Co\_trans}_{i , t} \qquad \# ( 1 )$$

$${Co\_trans}_{i , t} = {Loss\_trans}_{i , t} + {Op\_trans}_{i , t} \qquad \# ( 2 )$$

$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$

$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$

$${Op\_trans}_{i , t} = {Trans}_{i , t} * ( {Pf}_{t} + {Pu}_{t} ) \qquad \# ( 5 )$$

In the formulas, Cost_transᵢ represents the transformer costs in the ith time period, Co_trans_{i,t} represents the transformer costs of the tth transformer in the ith time period, Loss_trans_{i,t} represents the loss of the tth transformer in the ith time period, Op_trans_{i,t} represents the operation costs of the tth transformer in the ith time period, P0ₜ represents the active power of the tth transformer without load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer.

In some embodiments, the following formulas are used to calculate the switch costs in the plurality of time periods based on the purchase cost and service life of the switch corresponding to each of the transformers:

$${Cost\_breaker}_{i} = {\sum }_{n = 1}^{N} {Co\_breaker}_{i , n} \qquad \# ( 6 )$$

$${Co\_breaker}_{i , n} = {Br}_{i , n} * \frac{1}{{L}_{n}} * {C\_breaker}_{n} \qquad \# ( 7 )$$

In the formulas, Cost_breakerᵢ represents the switch costs in the ith time period, Co_breaker_{i,n} represents the switch costs of the nth switch in the ith time period, Br_{i,n} represents whether the nth switch is on in the ith time period, Lₙ represents the service life of the nth switch, and C_breakerₙ represents the purchase cost of the nth switch.

In some embodiments, the following formulas are used to calculate the total cost in the total time period based on the transformer costs and the switch costs and optimize the total cost to obtain optimization parameters:

$${Cost}_{i} = {Cost\_breaker}_{i} + {Cost\_trans}_{i} \qquad \# ( 8 )$$

$$Min ( {\int }_{i = 1}^{F} dt * {Cost}_{i} ) \qquad \# ( 9 )$$

$${Pl}_{i , t} \leq {Ps}_{t} \qquad \# ( 10 )$$

$${Pl}_{i , 1} + {Pl}_{i , 2} + … + {Pl}_{i , t} = {Load}_{i} \qquad \# ( 11 )$$

$${\sum }_{t = 1}^{T} ( {Trans}_{i , t} - {Trans}_{i - 1 , t} ) \leq 1 \qquad \# ( 12 )$$

In the formulas, formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period.

In some embodiments, the apparatus further comprises: calculating power reliability costs based on the predicted loads of each of the transformers, and calculating the total cost based on the transformer costs, the switch costs and the power reliability costs.

In some embodiments, the following formula is used to calculate the power reliability cost based on the predicted loads of each of the transformers:

$${Cost\_other}_{i} = \frac{1}{10 {\sum }_{t = 1}^{T} {Trans}_{i , t}} * {Load}_{i} \qquad ( 13 )$$

In the formula, Cost_otherᵢ represents the power reliability cost, Trans_{i,t} represents whether the tth transformer is online in the ith time period, and Loadᵢ represents the predicted load in the ith time period.

The present disclosure also describes electronic devices comprising a processor, a memory and an instruction stored in the memory, wherein the instruction, when executed by the processor, implements one or more of the methods as described herein.

The present disclosure also describes computer-readable storage media, with a computer instruction stored thereon, which, when run, executes one or more of the methods as described herein. To enable a clearer understanding of the technical features, objectives and effects of the teachings of the present disclosure, some specific embodiments are described below by referring to the drawings. In the following description, many specific details are provided to facilitate a full understanding of the present disclosure. However, the teachings may also be implemented in other ways different from those described herein. Therefore, the teachings are not limited to the specific embodiments disclosed below.

As shown in the application and the claims, unless the context clearly dictates otherwise, terms “a”, “an”, “one” and/or “the” are not intended to be specific in the singular and may include the plural. Generally, terms “comprising” and “including” only imply that the clearly identified steps and elements are included, these steps and elements do not constitute an exclusive list, and the method or device may also include other steps or elements.

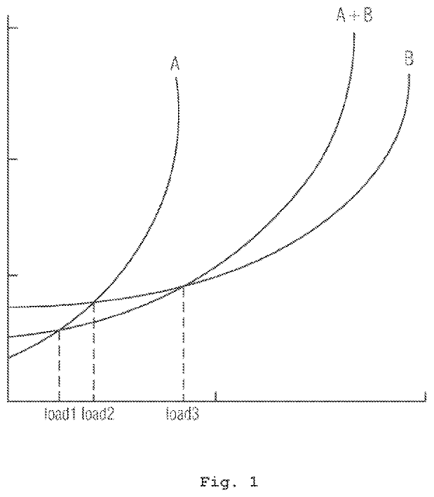

FIG. 1 is a schematic diagram of the transformer operation modes in the prior art, comprising two transformers, transformer A and transformer B. The two transformers have three operating modes, i.e., transformer A running alone, transformer B running alone, and transformers A and B running simultaneously. The operation curves of the three operating modes are respectively plotted. As shown in FIG. 1, the abscissa is the load current of transformer A, in amps, and the ordinate is the overall energy consumption, in volt-amperes. The three operation curves have three intersection points, namely load₁, load₂ and load₃. When the real-time load current is less than load₁, the overall energy consumption is the lowest if transformer A runs alone. When the real-time load is between load and load₃, the overall energy consumption is the lowest if transformers A and B run simultaneously. When the real-time load current is greater than load₃, the overall energy consumption is the lowest if transformer B runs alone. With this method, the curves of all possible operating models need to be plotted in advance, the cost factors and optimization time domain to be considered are limited, repeated switching may occur near the intersection points, which will shorten the service life of the transformers and at the same time increase power consumption.

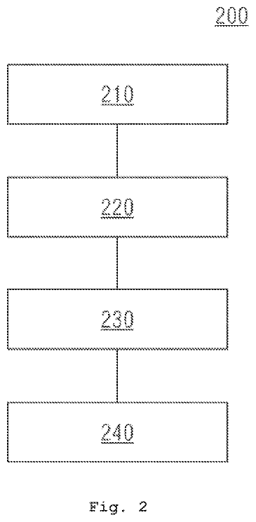

The present disclosure describes methods for optimizing the operation of a transformer substation, the transformer substation comprising a plurality of transformers, the transformers being connected or disconnected by means of switches. FIG. 2 is a flowchart of an example method 200 for optimizing the operation of a transformer substation incorporating teachings of the present disclosure. The optimization method 200 comprises:

Step 210, acquiring a current load of each of the plurality of transformers, and predicting predicted loads of each of the transformers in various possible operating modes in a plurality of time periods based on the current load. A neural network model may be trained first based on historical load data to predict each load and the total load of the substation. That is, the predicted loads of each transformer in a plurality of time periods may be calculated in each operating mode. For example, a substation comprises four transformers A, B, C, and D, with four operating modes, namely the first operating mode (with transformers ABC running), the second operating mode (with transformers ACD running), the third operating mode (with transformers ABD running), and the fourth operating mode (with transformers ABCD running). The current loads of the four transformers are acquired, and, based on the current loads, loads of each of the transformers are predicted, from the first operating mode to the fourth operating mode, at the first 15 minutes, the second 15 minutes, the third 15 minutes, and so on.

Step 220, calculating transformer costs of each of the transformers in the plurality of time periods based on the predicted loads of each of the transformers, the transformer costs comprising transformer losses and transformer operation costs. The costs of a transformer are related to the load, and the costs of each transformer in a plurality of time periods can be calculated based on the predicted loads of each transformer. Transformer costs comprise transformer losses and transformer operation costs. Transformer losses refer to the losses caused to a transformer itself when the transformer is running and can be calculated based on the predicted loads. Transformer operation costs refer to the costs of cooling and pumping a transformer while it is in operation.

In some embodiments, formulas (1) to (5) below are used to calculate the transformer costs of each of the transformers in the plurality of time periods based on the predicted loads of each of the transformers:

$${Cost\_trans}_{i} = {\sum }_{t = 1}^{T} {Co\_trans}_{i , t} \qquad \# ( 1 )$$

$${Co\_trans}_{i , t} = {Loss\_trans}_{i , t} + {Op\_trans}_{i , t} \qquad \# ( 2 )$$

$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$

$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$

$${Op\_trans}_{i , t} = {Trans}_{i , t} * ( {Pf}_{t} + {Pu}_{t} ) \qquad \# ( 5 )$$

In the formulas, Cost_transᵢ represents the transformer costs in the ith time period, Co_trans_{i,t} represents the transformer costs of the tth transformer in the ith time period, Loss_trans_{i,t} represents the loss of the tth transformer in the ith time period, Op_trans_{i,t} represents the operation costs of the tth transformer in the ith time period, P0ₜ represents the active power of the tth transformer without load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer.

Step 230, calculating switch costs in the plurality of time periods based on a purchase cost and a service life of a switch corresponding to each of the transformers. A transformer is connected or disconnected by means of switches, i.e., connected to or disconnected from the power grid by means of switches. Switch costs refer to the costs of connecting a transformer to the power grid or disconnecting it from the power grid by means of switches. These costs are related to the purchase cost and service life of the switches, and therefore the switch costs in a plurality of time periods can be calculated based on the purchase cost and service life of the switch corresponding to each transformer.

In some embodiments, formulas (6) and (7) below are used to calculate the switch costs in the plurality of time periods based on the purchase cost and service life of the switch corresponding to each of the transformers:

$${Cost\_breaker}_{i} = {\sum }_{n = 1}^{N} {Co\_breaker}_{i , n} \qquad \# ( 6 )$$

$${Co\_breaker}_{i , n} = {Br}_{i , n} * \frac{1}{{L}_{n}} * {C\_breaker}_{n} \qquad \# ( 7 )$$

In the formulas, Cost_breakerᵢ represents the switch costs in the ith time period, Co_breaker_{i,n} represents the switch costs of the nth switch in the ith time period, Br_{i,n} represents whether the nth switch is ON in the ith time period, with 1 representing ON and 0 representing OFF, Lₙ represents the service life of the nth switch, and C_breakerₙ represents the purchase cost of the nth switch.

| Trans_{i, t} | Br_{i, 1} | Br_{i, 2} |
|---|---|---|
| 0 | 0 | 0 |
| 1 | 1 | 1 |

The table above shows one possible relationship among the ON value Trans_{i,t} of a transformer, the ON value Br_{i,1} of the upstream switch of the transformer, and the ON value Br_{i,2} of the downstream switch. As shown in the table above, when the transformer is offline, both the upstream and the downstream switches are OFF, and, when the transformer is online, both the upstream and the downstream switches are ON.

Step 240, calculating a total cost in a total time period based on the transformer costs and the switch costs, optimizing the total cost to obtain optimization parameters, and operating the transformer substation according to the optimization parameters, the total time period consisting of the plurality of time periods. In some embodiments, after calculating the transformer costs and switching costs, the total cost in a total time period consisting of a plurality of time periods can be calculated by summing up the transformer costs and the switching costs. For example, the total costs in the first 15 minutes, the second 15 minutes, the third 15 minutes and so on until the 24th hour can be calculated respectively, and the sum of the total costs in these time periods is the total cost in the total time period. The total cost is a function of the transformer operating mode in the plurality of time periods. The corresponding transformer operation model when the total cost is minimized can be determined by optimizing the function of the total cost, i.e., solving the total cost function to obtain the optimal solution, for example, the total cost of the transformers reaching the lowest when transformers 1 to 4 run during the first hour, transformers 2 to 6 run during the second hour, etc. This operation mode can minimize the total cost of the transforms. After the optimization parameters are obtained, they are sent to an executor for execution.

In some embodiments, formulas (8) to (12) below are used to calculate the total cost in the total time period based on the transformer costs and the switch costs and optimize the total cost to obtain optimization parameters:

$${Cost}_{i} = {Cost\_breaker}_{i} + {Cost\_trans}_{i} \qquad \# ( 8 )$$

$$min ( {\int }_{i = 1}^{F} dt * {Cost}_{i} ) \qquad \# ( 9 )$$

$${Pl}_{i , t} \leq {Ps}_{t} \qquad \# ( 10 )$$

$${Pl}_{i , 1} + {Pl}_{i , 2} + … + {Pl}_{i , t} = {Load}_{i} \qquad \# ( 11 )$$

$${\sum }_{t = 1}^{T} ( {Trans}_{i , t} - {Trans}_{i - 1 , t} ) \leq 1 \qquad \# ( 12 )$$

In the formulas, formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period.

In some embodiments, the method further comprises: calculating power reliability costs based on the predicted loads of each of the transformers, and calculating the total cost based on the transformer costs, the switch costs and the power reliability costs.

In some embodiments, the following formula is used to calculate the power reliability cost based on the predicted loads of each of the transformers:

$${Cost\_other}_{i} = \frac{1}{10 {\sum }_{t = 1}^{T} {Trans}_{i , t}} * {Load}_{i} \qquad ( 13 )$$

In the formula, Cost_otherᵢ represents the power reliability cost, Trans_{i,t} represents whether the tth transformer is online in the ith time period, and Loadᵢ represents the predicted load in the ith time period.

The various example embodiments describe methods for optimizing the operation of a transformer substation. Predicted loads of each transformer are predicted based on current loads, the total cost in the total time period is calculated based on the transformer costs and the switch costs, and the total cost is optimized to obtain optimization parameters, which can be applied to the global time dimension without calculating the threshold in advance, thus preventing repeated switching of the operating modes near the threshold, eliminating the increase in losses and energy consumption due to unnecessary operations, reducing the operation loss and the energy usage costs, and improving the operation accuracy.

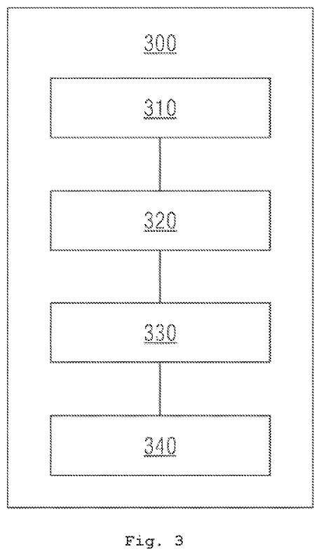

FIG. 3 is a schematic diagram of an example apparatus 300 for optimizing the operation of a transformer substation incorporating teachings of the present disclosure. As shown in FIG. 3, the optimization apparatus 300 comprises: a predicting module 310 that acquires a current load of each of the plurality of transformers and predicts predicted loads of each of the transformers in various possible operating modes in a plurality of time periods based on the current load, a first calculating module 320 that calculates transformer costs of each of the transformers in the plurality of time periods based on the predicted loads of each of the transformers, the transformer costs comprising transformer losses and transformer operation costs, a second calculating module 330 that calculates switch costs in the plurality of time periods based on a purchase cost and a service life of a switch corresponding to each of the transformers, and an optimizing module 440 that calculates a total cost in a total time period based on the transformer costs and the switch costs, optimizes the total cost to obtain optimization parameters, and operates the transformer substation according to the optimization parameters, the total time period consisting of the plurality of time periods.

In some embodiments, the following formulas are used to calculate the transformer costs of each of the transformers in the plurality of time periods based on the predicted loads of each of the transformers:

$${Cost\_trans}_{i} = {\sum }_{t = 1}^{T} {Co\_trans}_{i , t} \qquad \# ( 1 )$$

$${Co\_trans}_{i , t} = {Loss\_trans}_{i , t} + {Op\_trans}_{i , t} \qquad \# ( 2 )$$

$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$

$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$

$${Op\_trans}_{i , t} = {Trans}_{i , t} * ( {Pf}_{t} + {Pu}_{t} ) \qquad \# ( 5 )$$

In the formulas, Cost_transᵢ represents the transformer costs in the ith time period, Co_trans_{i,t} represents the transformer costs of the tth transformer in the ith time period, Loss_trans_{i,t} represents the loss of the tth transformer in the ith time period, Op_trans_{i,t} represents the operation costs of the tth transformer in the ith time period, P0ₜ represents the active power of the tth transformer without load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer.

In some embodiments, the following formulas are used to calculate the switch costs in the plurality of time periods based on the purchase cost and service life of the switch corresponding to each of the transformers:

$${Cost\_breaker}_{i} = {\sum }_{n = 1}^{N} {Co\_breaker}_{i , n} \qquad \# ( 6 )$$

$${Co\_breaker}_{i , n} = {Br}_{i , n} * \frac{1}{{L}_{n}} * {C\_breaker}_{n} \qquad \# ( 7 )$$

In the formulas, Cost_{breaker}_{ᵢ} represents the switch costs in the ith time period, Co_breaker_{i,n} represents the switch costs of the nth switch in the ith time period, Br_{i,n} represents whether the nth switch is on in the ith time period, Lₙ represents the service life of the nth switch, and C_breakerₙ represents the purchase cost of the nth switch.

In some embodiments, the following formulas are used to calculate the total cost in the total time period based on the transformer costs and the switch costs and optimize the total cost to obtain optimization parameters:

$${Cost}_{i} = {Cost\_breaker}_{i} + {Cost\_trans}_{i} \qquad \# ( 8 )$$

$$Min ( {\int }_{i = 1}^{F} dt * {Cost}_{i} ) \qquad \# ( 9 )$$

$${Pl}_{i , t} \leq {Ps}_{t} \qquad \# ( 10 )$$

$${Pl}_{i , 1} + {Pl}_{i , 2} + … + {Pl}_{i , t} = {Load}_{i} \qquad \# ( 11 )$$

$${\sum }_{t = 1}^{T} ( {Trans}_{i , t} - {Trans}_{i - 1 , t} ) \leq 1 \qquad \# ( 12 )$$

In the formulas, formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period.

In some embodiments, the apparatus further comprises: calculating power reliability costs based on the predicted loads of each of the transformers, and calculating the total cost based on the transformer costs, the switch costs and the power reliability costs.

In some embodiments, the following formula is used to calculate the power reliability cost based on the predicted loads of each of the transformers:

$${Cost\_other}_{i} = \frac{1}{10 {\sum }_{t = 1}^{T} {Trans}_{i , t}} * {Load}_{i} \qquad ( 13 )$$

In the formula, Cost_otherᵢ represents the power reliability cost, Trans_{i,t} represents whether the tth transformer is online in the ith time period, and Loadᵢ represents the predicted load in the ith time period.

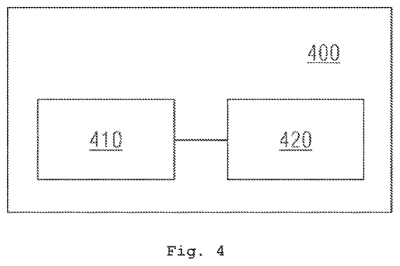

FIG. 4 is a schematic diagram of an example electronic device 400 incorporating teachings of the present disclosure. As shown in FIG. 4, the electronic device 400 comprises a processor 410 and a memory 420, with an instruction stored in the memory 420, wherein the instruction, when executed by the processor 410, implements the method 200 as described above.

Some elements of the methods and/or the devices may be implemented entirely by hardware or entirely by software (including firmware, resident software, microcode, etc.), or by a combination thereof. The above hardware or software may be referred to as a “data block”, “module”, “engine”, “unit”, “component” or “system”. The processor may be one or more application-specific integrated circuits (ASICs), digital signal processors (DSPs), digital signal processing devices (DAPDs), programmable logic devices (PLDs), field-programmable gate arrays (FPGAs), processors, controllers, microcontrollers, microprocessors, or a combination thereof. In addition, all aspects of the present invention may be embodied as a computer product comprising computer-readable program code in one or more computer-readable media. For example, the computer-readable media may include but are not limited to magnetic storage devices (for example, hard disks, floppy disks, magnetic tapes, . . . ), optical disks (for example, compact discs (CDs), digital versatile disks (DVDs), . . . ), and smart cards and flash memory devices (for example, cards, sticks, key drives, . . . ).

Flowcharts are used herein to illustrate the operations performed by an example method incorporating teachings of the present disclosure. It should be understood that these operations are not necessarily performed exactly in the order shown. Instead, the various steps may be processed in the reverse order or simultaneously. At the same time, other operations may be added to these processes, or a step or some steps may be removed from these processes.

It should be understood that, although this description covers various embodiments, not each embodiment contains only one independent technical solution. This way of description is only for clarity, and those skilled in the art should regard the description as a whole. The technical solutions in each embodiment can also be appropriately combined to form other implementations that can be understood by those skilled in the art.

The statements above are only illustrative specific embodiments and are not intended to limit the scope of the present disclosure. Any equivalent changes, modifications, and/or combinations made by anyone skilled in the art without departing from the concept and principle of the present disclosure shall fall within the scope thereof.

What is claimed is:

1. A method for optimizing operation of a transformer substation, the transformer substation including a plurality of transformers connected or disconnected by switches, the optimization method
acquiring a current load of each of the plurality of transformers, and predicting predicted loads of each of the plurality of transformers in various possible operating modes in a plurality of time periods based on the current load;
calculating transformer costs for each of the transformers in the plurality of time periods based on the predicted loads of each of the transformers, the transformer costs comprising transformer losses and transformer operation costs;
calculating switch costs in the plurality of time periods based on a purchase cost and a service life for a respective switch corresponding to each of the transformers; and
calculating a total cost in a total time period based on the transformer costs and the switch costs, optimizing the total cost to obtain optimization parameters, and operating the transformer substation according to the optimization parameters, the total time period consisting of the plurality of time periods.

2. The optimization method as claimed in claim 1, wherein calculating transformer costs of each of the transformers in the plurality of time periods based on the predicted loads of each of the transformers includes calculating:
$${Cost\_trans}_{i} = {\sum }_{t = 1}^{T} {Co\_trans}_{i , t} \qquad \# ( 1 )$$
$${Co\_trans}_{i , t} = {Loss\_trans}_{i , t} + {Op\_trans}_{i , t} \qquad \# ( 2 )$$
$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$
$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$
$${Op\_trans}_{i , t} = {Trans}_{i , t} * ( {Pf}_{t} + {Pu}_{t} ) \qquad \# ( 5 )$$
wherein Cost_transᵢ represents the transformer costs in the ith time period, Co_trans_{i,t} represents the transformer costs of the tth transformer in the ith time period, Loss_trans_{i,t} represents the loss of the tth transformer in the ith time period, Op_trans_{i,t} represents the operation costs of the tth transformer in the ith time period, P0ₜ represents the active power of the tth transformer without load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer.

3. The optimization method as claimed in claim 2, wherein calculating switch costs in the plurality of time periods based on a purchase cost and a service life of a switch corresponding to each of the transformers includes calculating:
$${Cost\_breaker}_{i} = {\sum }_{n = 1}^{N} {Co\_breaker}_{i , n} \qquad \# ( 6 )$$
$${Co\_breaker}_{i , n} = {Br}_{i , n} * \frac{1}{{L}_{n}} * {C\_breaker}_{n} \qquad \# ( 7 )$$
wherein Cost_breakerᵢ represents the switch costs in the ith time period, Co_breaker_{i,n} represents the switch costs of the nth switch in the ith time period, Br_{i,n} represents whether the nth switch is ON in the ith time period, Lₙ represents the service life of the nth switch, and C_breakerₙ represents the purchase cost of the nth switch.

4. The optimization method as claimed in claim 1, wherein calculating a total cost in a total time period based on the transformer costs and the switch costs and optimize the total cost to obtain optimization parameters includes calculating:
$${Cost}_{i} = {Cost\_breaker}_{i} + {Cost\_trans}_{i} \qquad \# ( 8 )$$
$$Min ( {\int }_{i = 1}^{F} dt * {Cost}_{i} ) \qquad \# ( 9 )$$
$${Pl}_{i , t} \leq {Ps}_{t} \qquad \# ( 10 )$$
$${Pl}_{i , 1} + {Pl}_{i , 2} + … + {Pl}_{i , t} = {Load}_{i} \qquad \# ( 11 )$$
$${\sum }_{t = 1}^{T} ( {Trans}_{i , t} - {Trans}_{i - 1 , t} ) \leq 1 \qquad \# ( 12 )$$
wherein formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period.

5. The optimization method as claimed in claim 1, further comprising:
calculating power reliability costs based on the predicted loads of each of the transformers; and
calculating the total cost based on the transformer costs, the switch costs and the power reliability costs.

6. The optimization method as claimed in claim 5, wherein calculating power reliability costs based on the predicted loads of each of the transformers includes calculating:
$${Cost\_other}_{i} = \frac{1}{10 {\sum }_{t = 1}^{T} {Trans}_{i , t}} * {Load}_{i} \qquad ( 13 )$$
wherein Cost_otherᵢ represents the power reliability cost, Trans_{i,t} represents whether the tth transformer is online in the ith time period, and Loadᵢ represents the predicted load in the ith time period.

7. An apparatus for optimizing operation of a transformer substation, the transformer substation including a plurality of transformers, connected or disconnected by switches, the optimization apparatus comprising:
a predicting module to acquire a current load of each of the plurality of transformers and predicts predicted loads of each of the transformers in various possible operating modes in a plurality of time periods based on the respective current load;
a first calculating module to calculate transformer costs of each of the transformers in the plurality of time periods based on the predicted loads of each of the transformers, the transformer costs comprising transformer losses and transformer operation costs;
a second calculating module to calculate switch costs in the plurality of time periods based on a purchase cost and a service life of a switch corresponding to each of the transformers; and
an optimizing module to calculate a total cost in a total time period based on the transformer costs and the switch costs, optimizes the total cost to obtain optimization parameters, and operates a transformer substation according to the optimization parameters, the total time period consisting of the plurality of time periods.

8. The optimization apparatus as claimed in claim 7, wherein the following formulas are used to calculate transformer costs of each of the transformers in the plurality of time periods based on the predicted loads of each of the transformers:
$${Cost\_trans}_{i} = {\sum }_{t = 1}^{T} {Co\_trans}_{i , t} \qquad \# ( 1 )$$
$${Co\_trans}_{i , t} = {Loss\_trans}_{i , t} + {Op\_trans}_{i , t} \qquad \# ( 2 )$$
$${Loss\_trans}_{i , t} = P {0}_{t} + {K}_{Q} * Q {0}_{t} + {Load}_{i}^{2} * ( {Pk}_{t} + {K}_{Q} * {Qk}_{t} ) * {( \frac{{D}_{t}}{{S}_{t}} )}^{2} \qquad \# ( 3 )$$
$${D}_{t} = \frac{\frac{{S}_{t}}{{D}_{t}} * {Trans}_{i , t}}{{\sum }_{t = 1}^{T} \frac{{S}_{t}}{{D}_{t}} * {Trans}_{i , t}} \qquad \# ( 4 )$$
$${Op\_trans}_{i , t} = {Trans}_{i , t} * ( {Pf}_{t} + {Pu}_{t} ) \qquad \# ( 5 )$$
wherein Cost_transᵢ represents the transformer costs in the ith time period, Co_trans_{i,t} represents the transformer costs of the tth transformer in the ith time period, Loss_trans_{i,t} represents the loss of the tth transformer in the ith time period, Op_trans_{i,t} represents the operation costs of the tth transformer in the ith time period, P0ₜ represents the active power of the tth transformer without load, K_{Q} represents the reactive power equivalent coefficient, Q0ₜ represents the reactive power of the tth transformer without load, Loadᵢ represents the predicted load in the ith time period, Pkₜ represents the active power of the tth transformer when shorted, Qkₜ represents the reactive power of the tth transformer when shorted, Dₜ represents the load factor of the tth transformer, Sₜ represents the rated power of the tth transformer, Trans_{i,t} represents whether the tth transformer is online in the ith time period, Pfₜ represents the power consumption of the cooling device of the tth transformer, and Put represents the power consumption of the oil-immersed pump of the tth transformer.

9. The optimization apparatus as claimed in claim 8, wherein the following formulas are used to calculate switch costs in the plurality of time periods based on a purchase cost and a service life of a switch corresponding to each of the transformers:
$${Cost\_breaker}_{i} = {\sum }_{n = 1}^{N} {Co\_breaker}_{i , n} \qquad \# ( 6 )$$
$${Co\_breaker}_{i , n} = {Br}_{i , n} * \frac{1}{{L}_{n}} * {C\_breaker}_{n} \qquad \# ( 7 )$$
wherein Cost_breakerᵢ represents the switch costs in the ith time period, Co_breaker_{i,n} represents the switch costs of the nth switch in the ith time period, Br_{i,n} represents whether the nth switch is ON in the ith time period, Lₙ represents the service life of the nth switch, and C_breakerₙ represents the purchase cost of the nth switch.

10. The optimization apparatus as claimed in claim 7, wherein the apparatus uses formulas to calculate a total cost in a total time period based on the transformer costs and the switch costs and optimize the total cost to obtain optimization parameters, the formulas comprising:
$${Cost}_{i} = {Cost\_breaker}_{i} + {Cost\_trans}_{i} \qquad \# ( 8 )$$
$$Min ( {\int }_{i = 1}^{F} dt * {Cost}_{i} ) \qquad \# ( 9 )$$
$${Pl}_{i , t} \leq {Ps}_{t} \qquad \# ( 10 )$$
$${Pl}_{i , 1} + {Pl}_{i , 2} + … + {Pl}_{i , t} = {Load}_{i} \qquad \# ( 11 )$$
$${\sum }_{t = 1}^{T} ( {Trans}_{i , t} - {Trans}_{i - 1 , t} ) \leq 1 \qquad \# ( 12 )$$
wherein formula (9) is an objective function, formulas (10) to (12) are constraints, Costᵢ represents the total cost in the ith time period, F represents the total time period, Pl_{i,t} represents the current power consumption of the tth transformer in the ith time period, Psₜ represents the rated power consumption of the tth transformer, Trans_{i,t} represents whether the tth transformer is online in the ith time period, and Trans_{i-1,t} represents whether the tth transformer is online in the (i−1)th time period.

11. The optimization apparatus as claimed in claim 7, wherein the calculating module further determines: power reliability costs based on the predicted loads of each of the transformers, and the total cost based on the transformer costs, the switch costs and the power reliability costs.

12. The optimization apparatus as claimed in claim 11, wherein the apparatus uses a formula to calculate power reliability costs based on the predicted loads of each of the transformers, the formula comprising:
$${Cost\_other}_{i} = \frac{1}{10 {\sum }_{t = 1}^{T} {Trans}_{i , t}} * {Load}_{i} \qquad ( 13 )$$
wherein Cost_otherᵢ represents the power reliability cost, Trans_{i,t} represents whether the tth transformer is online in the ith time period, and Load represents the predicted load in the ith time period.

13. An electronic device comprising:
a processor; and
a memory storing instructions;
wherein the instructions, when executed by the processor, cause the processor to:
acquire a current load of each of the plurality of transformers, and predicting predicted loads of each of the plurality of transformers in various possible operating modes in a plurality of time periods based on the respect current loads;
calculate transformer costs for each of the transformers in the plurality of time periods based on the predicted loads of each of the transformers, the transformer costs comprising transformer losses and transformer operation costs;
calculate switch costs in the plurality of time periods based on a purchase cost and a service life for a respective switch corresponding to each of the transformers; and
calculate a total cost in a total time period based on the transformer costs and the switch costs, optimizing the total cost to obtain optimization parameters, and operating the transformer substation according to the optimization parameters, the total time period consisting of the plurality of time periods.

14. (canceled)
